(19) United States
(12) Patent Application Publication
(10) Pub. No.: US 2026/0319195 A1
(43) Pub. Date: Oct. 15, 2026

(54) OPTICAL ASSEMBLY AND OPTICAL TRANSCEIVER MODULE

(71) Applicant: ACCELIGHT TECHNOLOGIES (WUHAN) INC., Wuhan (CN)

(72) Inventors: Gong-En GU, Pleasanton, CA (US); Michael Xiaoyan WEI, Pleasanton, CA (US); William STERLING, Pleasanton, CA (US); Meirong ZHANG, Wuhan (CN)

(73) Assignee: ACCELIGHT TECHNOLOGIES (WUHAN) INC., Wuhan (CN)

(21) Appl. No.: 19/687,238

(22) Filed: May 26, 2026

Related U.S. Application Data
(63) Continuation of application No. PCT/CN2026/084493, filed on Mar. 19, 2026.

(30) Foreign Application Priority Data
Jan. 24, 2025 (CN) 202520171785.2

(51) Int. Cl. G02B 6/42; G02B 6/293

(52) U.S. Cl. CPC G02B 6/4215; G02B 6/29382; G02B 6/428

(57) ABSTRACT

An optical assembly and an optical transceiver module includes a fiber optic connector component and a wavelength division multiplexing component. A first optical component configured to focus a light beam output from a fiber optic ferrule into an input end of the wavelength division multiplexing component is disposed between the fiber optic connector component and the wavelength division multiplexing component, and a second optical component configured to steer a light beam output from the wavelength division multiplexing component to a receiving end is disposed at an output end of the wavelength division multiplexing component. The present disclosure has the advantages of simple structure, convenient assembly, high coupling efficiency, low loss, and high channel quality.

### CROSS-REFERENCE TO RELATED APPLICATIONS

This application is a continuation of International Patent Application No. PCT/CN2026/084493 with a filing date of Mar. 19, 2026, designating the United States, now pending, and further claims priority to Chinese Patent Application No. 202520171785.2 with a filing date of Jan. 24, 2025. The content of the aforementioned applications, including any intervening amendments thereto, is incorporated herein by reference.

### TECHNICAL FIELD

The present disclosure belongs to the field of optical transceiver module technologies, and in particular, relates to an optical assembly and an optical transceiver module.

### BACKGROUND

With the rapid development of data centers, requirements for transmission rates in optical communication systems are constantly increasing. Following this development trend, traditional multi-mode optical fibers can no longer meet the demands of high-speed transmission, and single-mode optical fibers are gradually being introduced into high-speed optical transceiver module transmission systems. To effectively reduce optical fiber costs, the coarse wavelength division multiplexing (CWDM4) technology has been widely adopted.

In the field of data communication, four wavelengths (1271 nm to 1331 nm) close to a zero-dispersion point of a G.652 single-mode fiber are selected in the CWDM4 standard for transmission. Currently, the CWDM4 technology is primarily implemented in the following ways: an arrayed waveguide grating (AWG) solution and an integrated tunable laser (ITL) solution.

However, as the transmission rate of optical communication continues to increase, signal quality and channel loss are increasingly important, especially in long-distance transmission scenarios. For example, the aforementioned AWG solution has problems such as high channel loss and poor signal quality in long-distance transmission scenarios. The ITL solution has specific advantages relative to the AWG solution in long-distance transmission scenarios, but has a low chip yield and high transmission loss.

In view of the aforementioned problems, there is an urgent need to develop a new type of optical assembly to resolve these technical challenges and promote advancement of optical communication technology.

### SUMMARY OF PRESENT INVENTION

The technical problem to be resolved by the present disclosure is to provide, in view of the technical disadvantages in the conventional technology, an optical assembly for an optical transceiver module and an optical transceiver module, to achieve advantages of simple structure, convenient assembling, high coupling efficiency, low loss, and high channel quality.

The technical solution adopted by the present disclosure to resolve the technical problem is as follows: The present disclosure discloses an optical assembly, including a fiber optic connector component and a wavelength division multiplexing component, a first optical component configured to focus a light beam output from a fiber optic ferrule into an input end of the wavelength division multiplexing component is disposed between the fiber optic connector component and the wavelength division multiplexing component, and a second optical component configured to steer a light beam output from the wavelength division multiplexing component to a receiving end is disposed at an output end of the wavelength division multiplexing component.

In a preferred embodiment of the present disclosure, the second optical component includes a steering prism configured to steer the light beam output from the wavelength division multiplexing component.

In a preferred embodiment of the present disclosure, the second optical component includes a steering prism and a lens; the light beam is first steered by the steering prism and then converged and coupled to the lens at the receiving end, or the light beam can first pass through the lens and then pass through the steering prism to the receiving end.

In a preferred embodiment of the present disclosure, the steering prism includes a single prism, or the steering prism includes a plurality of sub-prisms, and the number of the sub-prisms corresponds to the number of light beams output from the wavelength division multiplexing component.

In a preferred embodiment of the present disclosure, the lens and the steering prism are integrally formed or separately assembled.

In a preferred embodiment of the present disclosure, the first optical component includes a collimating and focusing lens.

In a preferred embodiment of the present disclosure, the wavelength division multiplexing component includes a wavelength division multiplexer.

In a preferred embodiment of the present disclosure, the second optical component is a prism, or the wavelength division multiplexing component includes an input collimating lens, a wavelength division multiplexer, and an emergent lens.

In a preferred embodiment of the present disclosure, the fiber optic connector component includes an optical connector assembly, an optical fiber, and a fiber pigtail.

In a preferred embodiment of the present disclosure, angle tuning assemblies are disposed between the wavelength division multiplexing component and the second optical component, the angle tuning assemblies are arranged in one-to-one correspondence with filters disposed on the wavelength division multiplexing component, and each of the angle tuning assemblies includes an angle tuning element base and an angle tuning element that is mounted on the angle tuning element base and that is configured to finely adjust an angle of signal light.

In a preferred embodiment of the present disclosure, the fiber pigtail has various forms, including a cylindrical fiber optic ferrule, a single-core fiber array, a semi-circular shape, a square shape, or the like.

The present disclosure further discloses an optical transceiver module, including: a printed circuit board, where the printed circuit board is provided with an optical transceiver module receiving end and an optical assembly, and a light beam passes through the optical assembly and is received by the optical transceiver module receiving end.

In a preferred embodiment of the present disclosure, angle tuning assemblies are disposed between the wavelength division multiplexer and the second optical component, the angle tuning assemblies are arranged in one-to-one correspondence with filters disposed on the wavelength division multiplexer, and each of the angle tuning assemblies includes an angle tuning element base and an angle tuning element that is mounted on the angle tuning element base and that is configured to finely adjust an angle of signal light.

In a preferred embodiment of the present disclosure, the fiber pigtail includes a single-core fiber pigtail or a single-core fiber array.

The present disclosure further discloses an optical transceiver module, including the aforementioned optical assembly.

In a preferred embodiment of the present disclosure, the optical transceiver module is a high-speed optical transceiver module.

Beneficial effects of the present disclosure: The optical assembly provided in the present disclosure has a plurality of significant advantages by optimizing the optical path structure design. Firstly, a square fiber pigtail and a square cylindrical lens are used to effectively improve space utilization and mounting stability of components. Secondly, a wavelength division multiplexer is used in conjunction with a plurality of corresponding filters and angle tuning assemblies, to efficiently separate and precisely adjust multi-channel optical signals, thereby significantly improving signal quality and successfully overcoming the limitations of traditional arrayed waveguide gratings, including high loss, poor channel quality, and fixed component wavelength channels.

Furthermore, an innovative steering and focusing prism structure is introduced in the present disclosure. Angular rotation of the signal light is implemented by the steering prism, and a limiting lens is utilized to converge and couple the optical signal to not only optimize an optical path layout but also improve photoelectric conversion efficiency. An array lens and a prism are delicately combined to further enhance efficiency of coupling to the photodetector. This design allows the photodetector to be mounted on a side surface of a substrate, effectively improving space utilization efficiency.

Furthermore, the present disclosure can effectively suppress back reflection and achieve precise adjustment of an angle of the optical signal. The optical portion in a high-speed optical transceiver module is integrated into a single assembly, to greatly reduce assembling steps of the optical transceiver module significantly, and improve module assembling efficiency. The introduced limiting block design makes the coupling and mounting of the optical assembly simpler and more precise. This optical path design not only reduces channel loss but also enhances overall transmission performance of the system, thereby meeting demands for flexible wavelength allocation and dynamic routing in optical communication networks, and increasing a transmission rate of the optical transceiver module and supporting complex modulation formats.

### BRIEF DESCRIPTION OF THE DRAWINGS

The present disclosure is described in further detail with reference to the accompanying drawings and embodiments. In the drawings:

FIG. 1 is a schematic diagram showing an optical assembly for an optical transceiver module according to Embodiment 1 of the present disclosure;

FIG. 2 is a top view of an optical assembly for an optical transceiver module according to the present disclosure;

FIG. 3 is a main view of an optical assembly for an optical transceiver module according to the present disclosure;

FIG. 4 is a partially enlarged view of FIG. 3;

FIG. 5 is a schematic diagram according to Embodiment 2 of the present disclosure;

FIG. 6 is a partially enlarged view of FIG. 5;

FIG. 7 is a schematic diagram according to Embodiment 3 of the present disclosure;

FIG. 8 is a partially enlarged view of FIG. 7;

FIG. 9 is a schematic diagram according to Embodiment 4 of the present disclosure;

FIG. 10 is a partially enlarged view of FIG. 9;

FIG. 11 is a schematic diagram according to Embodiment 5 of the present disclosure;

FIG. 12 is a schematic diagram according to Embodiment 5 of the present disclosure; and

FIG. 13 is a partially enlarged view of FIG. 12.

### DETAILED DESCRIPTION OF THE EMBODIMENTS

In order to make the objectives, technical solutions, and advantages of the present disclosure clearer, the present disclosure is further described in detail below with reference to the accompanying drawings and examples. It should be understood that the specific embodiments described herein are intended merely to explain the present disclosure, rather than to limit the present disclosure.

### Embodiment 1

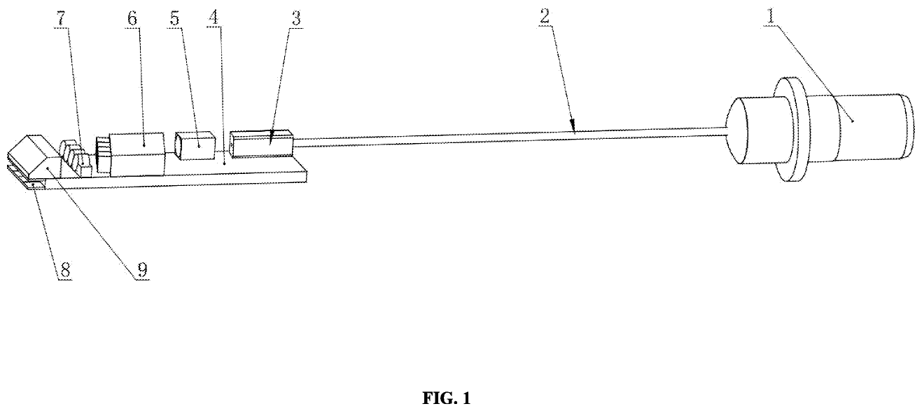

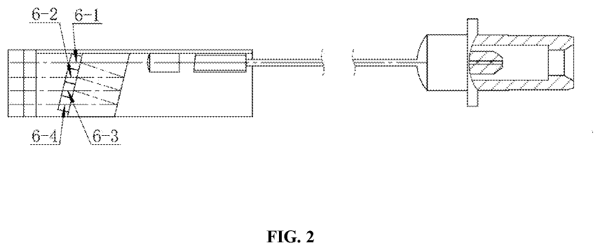

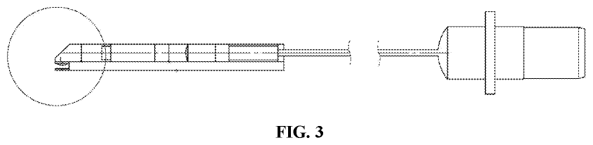

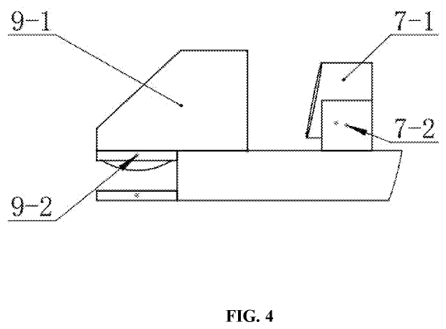

As shown in FIG. 1 to FIG. 4, the present disclosure provides a prism and wavelength division multiplexer assembly, configured to steer and couple light into a photodetector, that can better meet development demands of future optical communication systems, can meet higher transmission rates and more complex modulation formats, and has low loss and high channel quality.

An optical assembly for an optical transceiver module provided in the present disclosure includes an optical connector assembly 1, an optical fiber 2, a collimating and focusing lens 5, a wavelength division multiplexing component 6, a second optical component, and a photodetector 8. The photodetector 8 is a receiving end. The second optical component is configured as a steering prism 9 and a lens 10. The wavelength division multiplexing component 6 is configured as a wavelength division multiplexer. Efficient optical signal transmission and processing functions are achieved by these components through a specific spatial layout and optical path design.

In terms of an optical path layout, the optical connector assembly 1, the optical fiber 2, and the collimating and focusing lens 5 are arranged coaxially in sequence according to an optical signal transmission direction. A fiber pigtail 3 is disposed at an end portion of the optical fiber 2. This fiber pigtail 3 has a square design and is located between the collimating and focusing lens 5 and the optical connector assembly 1. The collimating and focusing lens 5 is designed as a square cylindrical lens, thereby helping improve mounting stability and space utilization.

The wavelength division multiplexing component 6, the steering prism 9, and the photodetector 8 are sequentially disposed downstream of the collimating and focusing lens 5. A first filter 6-1, a second filter 6-2, a third filter 6-3, and a fourth filter 6-4 are disposed on the wavelength division multiplexing component 6. These filters are disposed in one-to-one correspondence with angle tuning assemblies 7 to achieve precise demultiplexing of optical signals.

The steering prism 9 and the lens 10 are innovative design points of the present disclosure. The steering prism 9 includes two functional components: the steering prism 9 configured to implement angular rotation of the signal light, and the lens 10 connected to the steering prism 9. The steering prism 9 has an inclined surface forming a 135° included angle with an optical path. Through this specific angle design, the optical signal can be precisely steered. The lens 10 is configured to converge and couple the steered optical signal and is disposed in one-to-one correspondence with the photodetector 8 to ensure efficient transmission of the optical signal to the photodetector 8. The optical signal enters the steering prism 9, is steered by the steering prism 9, is converged by the lens 10, and is ultimately transmitted to the photodetector 8 for detection and processing. Alternatively, the optical signal can first pass through the lens 10 and then pass through the steering prism 9 to the receiving end.

Furthermore, the entire optical assembly in the present disclosure uses a substrate 4 as a carrier platform, and all optical components are fastened to this substrate. Specifically, the fiber pigtail 3, the collimating and focusing lens 5, the wavelength division multiplexing component 6, and the steering prism 9 are all fastened to an upper end surface of the substrate 4 through adhesive bonding, and the photodetector 8 is adhesively bonded to a side end surface of the substrate 4. This layout design not only optimizes space utilization but also facilitates component mounting and maintenance. The photodetector 8 may alternatively be disposed on another component instead of being connected to the substrate 4.

During actual operation, after signal light is received by an optical receiver RX port, an optical signal is transmitted to the fiber pigtail 3 after sequentially passing through the optical connector assembly 1 and the optical fiber 2. Light emitted from the fiber pigtail 3 is focused and collimated by the collimating and focusing lens 5 before being transmitted to the wavelength division multiplexing component 6. Within the wavelength division multiplexing component 6, the optical signal is split into signals of different wavelengths through a filtering action of the first filter 6-1, second filter 6-2, third filter 6-3, and fourth filter 6-4. The optical signal enters the steering prism 9, is steered by the steering prism 9, is converged by the lens 10, and is ultimately transmitted to the photodetector 8 for detection and processing.

Transmission loss of the optical signal is significantly reduced by the prism and wavelength division multiplexer assembly disclosed in the present disclosure, thereby improving channel quality, and better adapting to the requirements of high-speed transmission and complex modulation formats in future optical communication systems. All components are precisely fastened to substrate 4 through an accurate bonding process, ensuring the stability and reliability of the entire optical system.

Furthermore, the present disclosure allows for the addition of angle tuning assemblies 7 between the wavelength division multiplexing component 6 and the steering prism 9. Each of the angle tuning assemblies 7 includes two key parts: an angle tuning element base 7-2 and an angle tuning element 7-1 mounted on the angle tuning element base 7-2, and the angle tuning element 7-1 is configured to precisely fine-tune an angle of signal light. After the angle tuning assemblies 7 are added, within the wavelength division multiplexing component 6, the optical signal is split into signals of different wavelengths through the filtering action of the first filter 6-1, second filter 6-2, third filter 6-3, and fourth filter 6-4. These demultiplexed signals are respectively transmitted to the corresponding angle tuning assemblies 7. After being subject to angular fine-tuning by the angle tuning elements 7-1, the demultiplexed signals enter the steering prism 9, are steered by the steering prism 9, are converged by the lens 10, and are ultimately transmitted to the photodetector 8 for detection and processing.

### Embodiment 2

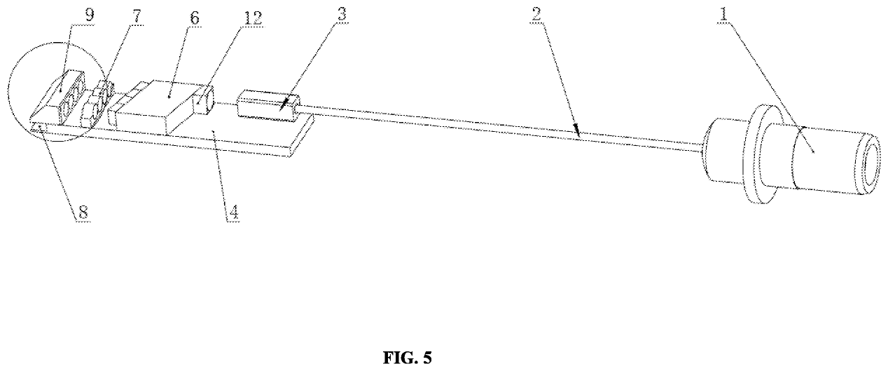

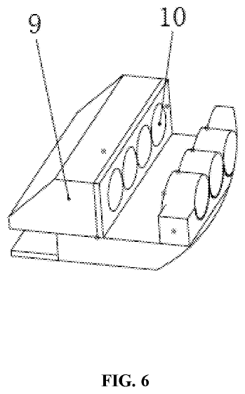

As shown in FIG. 5 and FIG. 6, the present disclosure provides another design solution of an optical assembly. An optical path structure is optimized in this solution, to reduce coupling times of an optical signal, and further enhance system transmission efficiency. A specific implementation of this embodiment is described below:

The optical assembly provided in this embodiment is used in an optical transceiver module having a two-layer layout design. An upper layer includes an optical connector assembly 1, an optical fiber 2, and a wavelength division multiplexing component 6. A photodetector 8 is disposed at a lower layer. A fiber pigtail 3 is disposed at an end portion of the optical fiber 2, and the fiber pigtail 3 is located between the optical connector assembly 1 and the wavelength division multiplexing component 6 to achieve stable transmission of the optical signal.

An important innovation of this embodiment lies in the provision of a first optical component between the optical connector assembly 1 and the wavelength division multiplexing component 6. The first optical component is configured as a collimating and focusing lens 5. The collimating and focusing lens 5 may be a beveled prism lens, and is mainly configured to focus an output light beam and accurately input the light beam into an input end of the wavelength division multiplexing component 6. By directly bonding the beveled prism lens with the wavelength division multiplexing component 6, coupling loss of the optical signal is significantly reduced.

In this embodiment, a second optical component configured to achieve steering transmission of the light beam is disposed between the wavelength division multiplexing component 6 and the photodetector 8. This component includes two key components: a lens 10 and a steering prism 9. Convergence coupling is first performed by the lens 10 on the light beam, and then the converged light beam is steered by the steering prism 9 to the photodetector 8. This processing sequence (“focus first, then steer”) is another innovation of this embodiment.

To precisely adjust the optical signal, angle tuning assemblies 7 are disposed between the wavelength division multiplexing component 6 and the second optical component. Each of the angle tuning assemblies 7 includes two parts: an angle tuning element base 7-2 and an angle tuning element 7-1 mounted on the angle tuning element base. These angle tuning assemblies are disposed in one-to-one correspondence with filters on the wavelength division multiplexing component 6. An angle of the signal light is precisely fine-tuned via the angle tuning elements 7-1.

During actual operation, after signal light is received by an optical receiver RX port, an optical signal is transmitted to the fiber pigtail 3 after sequentially passing through the optical connector assembly 1 and the optical fiber 2. The light emitted from the fiber pigtail 3 is focused and collimated by the beveled prism lens and transmitted to the wavelength division multiplexing component 6. After being demultiplexed by the wavelength division multiplexing component 6, the optical signal is transmitted to the corresponding angle tuning elementangle tuning assemblies 7 for angular fine-tuning. Then, a focal length of the signal light is adjusted by the lens 10, and finally, the optical signal is transmitted by the steering prism 9 to the photodetector 8 for detection and processing. All components are fastened to the substrate 4 using a reliable bonding process, ensuring system stability.

Compared with Embodiment 1, this embodiment features two main technological innovations: First, the collimating lens is replaced with a beveled prism lens matching the angle of the wavelength division multiplexing component 6, and is directly bonded to the wavelength division multiplexing component 6, effectively reducing one optical signal coupling stage; second, regarding the processing sequence of the optical signal, a “focus first, then steer” design is adopted, further optimizing optical transmission efficiency. These innovative designs allow this embodiment to further reduce system transmission loss while maintaining high channel quality.

### Embodiment 3

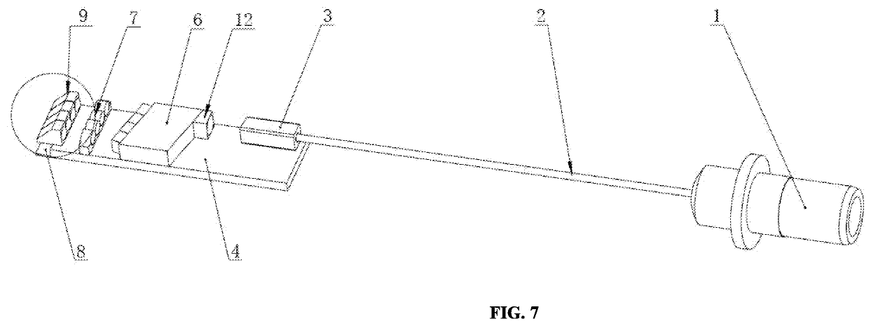

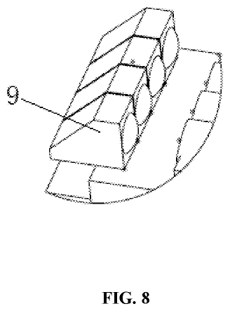

As shown in FIG. 7 and FIG. 8, the present disclosure provides another design solution of an optical assembly. An optical path structure is optimized in this solution, to reduce coupling times of an optical signal, and further enhance system transmission efficiency. A specific implementation of this embodiment is described below:

The optical assembly provided in this embodiment is used in an optical transceiver module having a two-layer layout design. An upper layer includes an optical connector assembly 1, an optical fiber 2, and a wavelength division multiplexing component 6. A photodetector 8 is disposed at a lower layer. A fiber pigtail 3 is disposed at an end portion of the optical fiber 2, and is configured to achieve stable transmission of an optical signal.

The optical assembly includes a beveled prism lens that is directly connected to the wavelength division multiplexing component 6, and is mainly configured to focus an output light beam and accurately input the output light beam into an input end of the wavelength division multiplexing component 6. By directly bonding the beveled prism lens with the wavelength division multiplexing component 6, coupling loss of the optical signal is significantly reduced.

In this embodiment, a second optical component configured to achieve steering transmission of a light beam is disposed between the wavelength division multiplexing component 6 and the photodetector 8. The optical assembly includes two key components: an integrated lens 10 and a steering prism 9. Convergence coupling is first performed by the lens 10 on the light beam, and then the converged light beam is steered by the steering prism 9 to the photodetector 8. This processing sequence (“focus first, then steer”) is another innovation of this embodiment.

Furthermore, the steering prism 9 includes four sub-prisms of a same shape. The number of sub-prisms corresponds to the number of light beams output from the wavelength division multiplexing component 6. Optical path steering, collimation, and convergence are respectively performed by the four sub-prisms of the same shape on four channels of signal light, thereby improving coupling efficiency.

To precisely adjust the optical signal, angle tuning elementangle tuning assemblies 7 are disposed between the wavelength division multiplexing component 6 and the second optical component. Each of the angle tuning assemblies 7 includes two parts: an angle tuning element base 7-2 and an angle tuning element 7-1 mounted on the angle tuning element base. These angle tuning assemblies are disposed in one-to-one correspondence with filters on the wavelength division multiplexing component 6. An angle of the signal light is precisely fine-tuned via the angle tuning elements 7-1.

During actual operation, after signal light is received by an optical receiver RX port, an optical signal is transmitted to the fiber pigtail 3 after sequentially passing through the optical connector assembly 1 and the optical fiber 2. The light emitted from the fiber pigtail 3 is focused and collimated by the beveled prism lens and transmitted to the wavelength division multiplexing component 6. After being demultiplexed by the wavelength division multiplexing component 6, the optical signal is transmitted to the corresponding angle tuning assemblies 7 for angular fine-tuning. Then, a focal length of the signal light is adjusted by the lens 10, and finally, the optical signal is transmitted by the steering prism 9 to the photodetector 8 for detection and processing. All components are fastened to the substrate 4 using a reliable bonding process, ensuring system stability.

This embodiment features two main technological innovations: Compared with a single, elongated, integral prism structure in Embodiment 1 and Embodiment 2, a split structure where each channel is independent is adopted in the present disclosure. These innovative designs allow this embodiment to further reduce system transmission loss while maintaining high channel quality.

### Embodiment 4

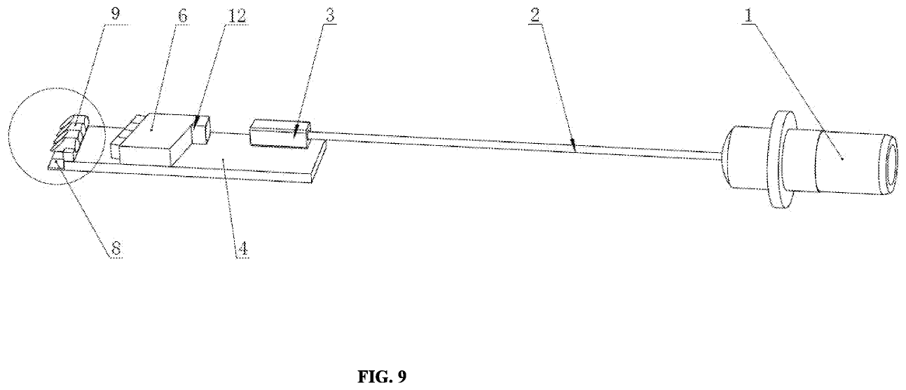

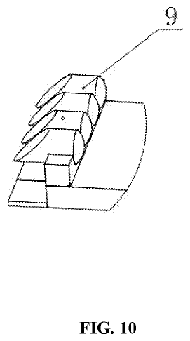

As shown in FIG. 9 and FIG. 10, the present disclosure provides a third design solution of an optical assembly. A steering collimating lens design is innovatively used in this solution, integrating functions of collimating/converging and steering an optical signal. A specific implementation of this embodiment is described below:

The optical assembly provided in this embodiment is used in an optical transceiver module also having a two-layer layout design. An upper layer includes an optical connector assembly 1, an optical fiber 2, and a wavelength division multiplexing component 6. A photodetector 8 is disposed at a lower layer. A fiber pigtail 3 is disposed at an end portion of the optical fiber 2, and is configured to ensure stable transmission of an optical signal.

In this embodiment, a first optical component is provided, including a beveled prism lens directly connected to the wavelength division multiplexing component 6. The beveled prism lens is mainly configured to focus a light beam and accurately input the light beam into an input end of the wavelength division multiplexing component 6. By directly connecting the beveled prism lens to the wavelength division multiplexing component 6, coupling loss of the optical signal is significantly reduced.

The core innovation of this embodiment lies in a design of a second optical component. This component has four steering prisms 9, and each steering prism 9 has dual functions of beam collimation/convergence and optical path steering. This innovative design integrates the functions of collimation/convergence and steering, which were previously accomplished by separate components, into a single component, significantly simplifying an optical path structure. A cross-section of the steering prism 9 can be selected from various shapes according to specific application requirements, including circular, semi-circular, sector-shaped, or polygonal. This flexible design offers more options for different application scenarios.

During actual operation, after signal light is received by an optical receiver RX port, an optical signal is transmitted to the fiber pigtail 3 after sequentially passing through the optical connector assembly 1 and the optical fiber 2. The light emitted from the fiber pigtail 3 is focused and collimated by the beveled prism lens and transmitted to the wavelength division multiplexing component 6. After being demultiplexed by the wavelength division multiplexing component 6, optical signals of different wavelengths are transmitted to steering prisms 9. Upon receiving the optical signal, both collimation/convergence and optical path steering functions are simultaneously completed by each steering prism 9, to directly transmit the processed optical signal to the photodetector 8 for detection and processing.

Compared with that of the previous two embodiments, the main technological innovation of this embodiment lies in the design of the steering prism 9 with higher functional integration. This design not only simplifies the optical path structure and reduces the number of components, but also improves system integration and reliability. By integrating collimation/convergence and optical path steering functions into a single component, transmission efficiency of the optical signal is further optimized, and space utilization of the system is also enhanced. This innovative design enables this embodiment to achieve a more compact and efficient system structure while maintaining excellent optical performance.

### Embodiment 5

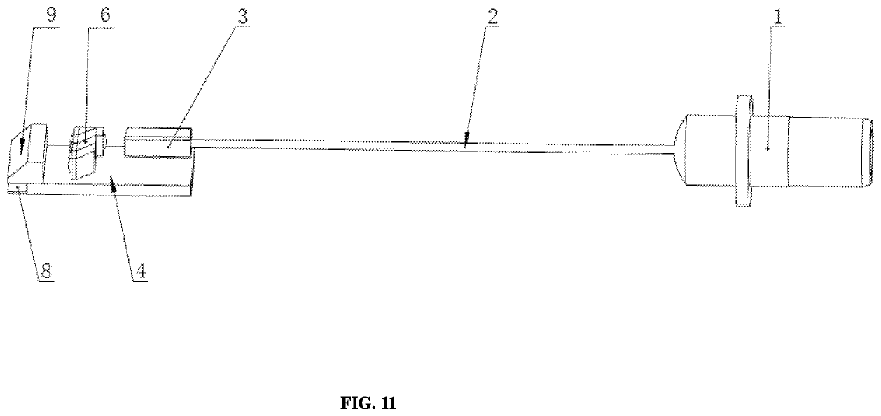

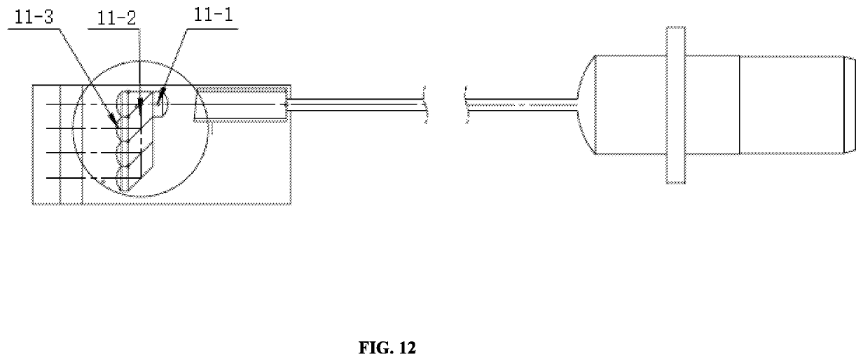

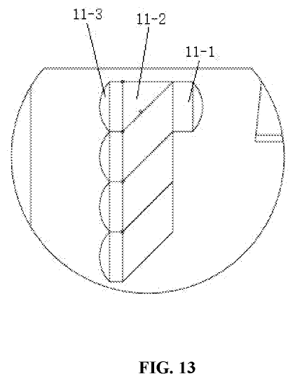

As shown in FIG. 11 to FIG. 13, the present disclosure provides an optical assembly design solution that achieves component miniaturization and simplified assembly processes through an integrated wavelength division multiplexing component design and an innovative optical path layout. The optical assembly provided in this embodiment is used in an optical transceiver module also having a two-layer layout design. An upper layer includes an optical connector assembly 1, an optical fiber 2, and a wavelength division multiplexing component 6. A photodetector 8 is disposed at a lower layer. A fiber pigtail 3 is provided at an end portion of the optical fiber 2, and the fiber pigtail 3 is located between the wavelength division multiplexing component 6 and the optical connector assembly 1.

The core innovation of this embodiment lies in an integrated design of the wavelength division multiplexing component 6. This wavelength division multiplexing component 6 is formed by tightly integrating three functional modules: an input collimating lens 11-1, a wavelength division multiplexer 11-2, and an emergent lens 11-3. The input collimating lens 11-1 is configured to collimate and focus/converge a light beam. The wavelength division multiplexer 11-2 employs a dichroic mirror, and is configured to implement multiplexing/demultiplexing of an optical signal. The emergent lens 11-3 is configured to collimate and focus four channels of demultiplexed signal light.

This embodiment employs, between the wavelength division multiplexing component 6 and the photodetector 8, a prism as the second optical component to steer and transmit a light beam output from the wavelength division multiplexer to the photodetector 8. This design simplifies the optical path structure while ensuring good optical signal transmission performance.

During actual operation, after signal light is received by an optical receiver RX port, an optical signal is transmitted to the fiber pigtail 3 after sequentially passing through the optical connector assembly 1 and the optical fiber 2. Subsequently, the optical signal enters the wavelength division multiplexing component 6, is focused by the input collimating lens 11-1, and is demultiplexed in the wavelength division multiplexer 11-2. The demultiplexed optical signals are collimated and focused by the emergent lens 11-3, and finally, the optical signals are steered and transmitted by the prism to the photodetector 8 for detection and processing. All components are fastened to the substrate 4 using a reliable bonding process, ensuring system stability.

In comparison with Embodiment 1 to Embodiment 4, the main technological innovation of this embodiment lies in replacing the wavelength division multiplexer structure with a dichroic mirror-based multiplexer/demultiplexer and tightly integrating the input collimating lens and the emergent lens array. This design significantly reduces the process difficulty of coupling and mounting the component, greatly reduces an overall size of the component, achieves a higher degree of miniaturization, simultaneously improves system integration and reliability, simplifies an assembling process, and enhances production efficiency. This highly integrated design solution not only maintains excellent optical performance but also provides an effective solution for miniaturization and mass production of optical transceiver modules.

It should be understood that those of ordinary skill in the art can make improvements or transformations based on the above description, and all these improvements and transformations should fall within the protection scope of the appended claims of the present disclosure.

What is claimed is:

1. An optical assembly, comprising: a fiber optic connector component and a wavelength division multiplexing component (6), wherein a first optical component configured to focus a light beam output from a fiber optic ferrule into an input end of the wavelength division multiplexing component (6) is disposed between the fiber optic connector component and the wavelength division multiplexing component (6), and a second optical component configured to steer a light beam output from the wavelength division multiplexing component (6) to a receiving end is disposed at an output end of the wavelength division multiplexing component (6).

2. The optical assembly according to claim 1, wherein the second optical component comprises a steering prism (9) configured to steer the light beam output from the wavelength division multiplexing component.

3. The optical assembly according to claim 1, wherein the second optical component comprises a steering prism (9) and a lens (10).

4. The optical assembly according to claim 2, wherein the steering prism (9) comprises a single prism; alternatively the steering prism (9) comprises a plurality of sub-prisms, and the number of the sub-prisms corresponds to the number of light beams output from the wavelength division multiplexing component (6).

5. The optical assembly according to claim 3, wherein the steering prism (9) comprises a single prism; alternatively the steering prism (9) comprises the number of sub-prisms, and the number of the sub-prisms corresponds to the number of light beams output from the wavelength division multiplexing component (6).

6. The optical assembly according to claim 3, wherein the lens (10) and the steering prism (9) are integrally formed or separately assembled.

7. The optical assembly according to claim 1, wherein the first optical component comprises a collimating and focusing lens (5).

8. The optical assembly according to claim 1, wherein the second optical component is a prism, or the wavelength division multiplexing component (6) comprises an input collimating lens (11-1), a wavelength division multiplexer (11-2), and an emergent lens (11-3).

9. The optical assembly according to claim 1, wherein the fiber optic connector component comprises an optical connector assembly (1), an optical fiber (2), and a fiber pigtail (3).

10. The optical assembly according to claim 1, wherein angle tuning assemblies (7) are disposed between the wavelength division multiplexing component (6) and the second optical component, the angle tuning assemblies (7) are arranged in one-to-one correspondence with filters disposed on the wavelength division multiplexing component (6), and each of the angle tuning assemblies (7) comprises a angle tuning element base (7-2) and an angle tuning element (7-1) mounted on the angle tuning element base (7-2) and configured to finely adjust an angle of signal light.

11. An optical transceiver module, comprising: a printed circuit board, wherein the printed circuit board is provided with an optical transceiver module receiving end and the optical assembly according to claim 1, and a light beam passes through the optical assembly and is received by the optical transceiver module receiving end.

12. An optical transceiver module, comprising: a printed circuit board, wherein the printed circuit board is provided with an optical transceiver module receiving end and the optical assembly according to claim 2, and a light beam passes through the optical assembly and is received by the optical transceiver module receiving end.

13. An optical transceiver module, comprising: a printed circuit board, wherein the printed circuit board is provided with an optical transceiver module receiving end and the optical assembly according to claim 3, and a light beam passes through the optical assembly and is received by the optical transceiver module receiving end.

14. An optical transceiver module, comprising: a printed circuit board, wherein the printed circuit board is provided with an optical transceiver module receiving end and the optical assembly according to claim 4, and a light beam passes through the optical assembly and is received by the optical transceiver module receiving end.

15. An optical transceiver module, comprising: a printed circuit board, wherein the printed circuit board is provided with an optical transceiver module receiving end and the optical assembly according to claim 5, and a light beam passes through the optical assembly and is received by the optical transceiver module receiving end.

16. An optical transceiver module, comprising: a printed circuit board, wherein the printed circuit board is provided with an optical transceiver module receiving end and the optical assembly according to claim 6, and a light beam passes through the optical assembly and is received by the optical transceiver module receiving end.

17. An optical transceiver module, comprising: a printed circuit board, wherein the printed circuit board is provided with an optical transceiver module receiving end and the optical assembly according to claim 7, and a light beam passes through the optical assembly and is received by the optical transceiver module receiving end.

18. An optical transceiver module, comprising: a printed circuit board, wherein the printed circuit board is provided with an optical transceiver module receiving end and the optical assembly according to claim 8, and a light beam passes through the optical assembly and is received by the optical transceiver module receiving end.

19. An optical transceiver module, comprising: a printed circuit board, wherein the printed circuit board is provided with an optical transceiver module receiving end and the optical assembly according to claim 9, and a light beam passes through the optical assembly and is received by the optical transceiver module receiving end.

20. An optical transceiver module, comprising: a printed circuit board, wherein the printed circuit board is provided with an optical transceiver module receiving end and the optical assembly according to claim 10, and a light beam passes through the optical assembly and is received by the optical transceiver module receiving end.
